(19) United States
(12) Patent Application Publication
(10) Pub. No.: US 2016/0181738 A1
(43) Pub. Date: Jun. 23, 2016

(54) AUTOMATIC TELESCOPIC CONNECTOR AND ELECTRONIC DEVICE USING THE SAME

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: MIN YANG, Wuhan (CN); XIN-SHU WANG, Wuhan (CN); JIAN-HUNG HUNG, New Taipei (TW)

(21) Appl. No.: 14/595,424

(22) Filed: Jan. 13, 2015

(30) Foreign Application Priority Data
Dec. 19, 2014 (CN) 201410792361.4

(51) Int. Cl. H01R 13/66; G06F 1/16

(52) U.S. Cl. CPC H01R 13/6691; G06F 1/1684

(57) ABSTRACT

An automatic telescopic connector includes an interface module and a transmission module. The interface module includes a trigger unit, a connector, and a telescopic bracket. The bracket includes a fixture. The trigger unit is configured to sense an input signal and output a trigger signal when the input signal meets a trigger condition. The transmission module is coupled to the interface module. The automatic telescopic connector is coupled to the control module. The control module outputs different signals to control the connector of the interface module to connect a connector of the external device or to disconnect from the connector of the external device.

### FIELD

The subject matter herein generally relates to an automatic telescopic connector and an electronic device using the automatic telescopic connector.

### BACKGROUND

An external device, such as a universal serial bus (USB) flash disk, is plugged in or unplugged manually.

### BRIEF DESCRIPTION OF THE DRAWING

Implementations of the present technology will now be described, by way of example only, with reference to the attached figure.

FIG. 1 is a block diagram of an embodiment of an electronic device including an automatic telescopic connector.

FIG. 2 is a block diagram of the automatic telescopic connector of FIG. 1.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

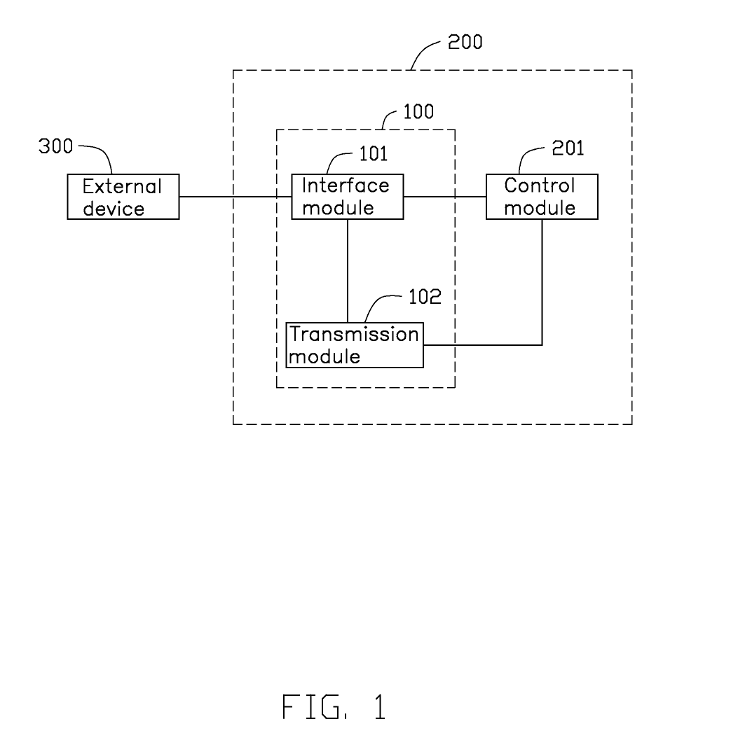

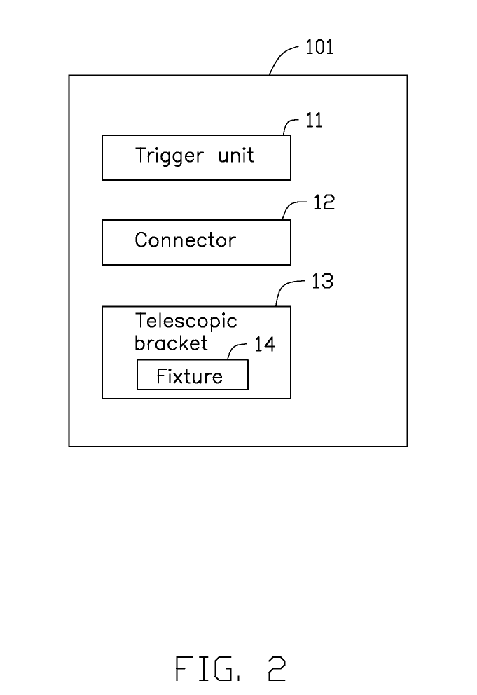

FIG. 1 and FIG. 2 show an embodiment of an automatic telescopic connector 100.

The automatic telescopic connector 100 comprises an interface module 101 and a transmission module 102. The electronic device 200 comprises the automatic telescopic connector 100 and a control module 201.

The interface module 101 comprises a trigger unit 11, a connector 12, and a telescopic bracket 13 around the connector 12. The telescopic bracket 13 further comprises a fixture 14. The trigger unit 11 is configured to sense an input signal. The trigger unit 11 outputs a trigger signal when the input signal meets a trigger condition. The transmission module 102 is coupled to the interface module 101. When the control module 201 receives the trigger signal a first control signal is output to the interface module 101. When the control module 201 receives the trigger signal a second control signal is also output to the transmission module 102. When the first control signal is received by the interface module 101, the telescopic bracket 13 is fixed to a connector of an external device 300 through the fixture 14. The transmission module 102 controls the telescopic bracket 13 to compress the connector 12 of the interface module 101 to connect to the connector of the external device 300 when the transmission module 102 receives the first control signal.

In the embodiment, the telescopic bracket 13 can be made of metal. The fixture 14 can be a clasp. The connector 12 can be a USB connector. The transmission module 102 comprises at least one belt. The trigger unit 11 can be a pressure sensor. The electronic device 200 can be a computer. The control module 201 can be a central processing unit (CPU) or an embedded controller (EC) of the computer.

In use, the trigger unit 11 senses pressure from the connector of the external device 300 which is ready to connect the interface module 101. The trigger unit 11 outputs the trigger signal to the control module 201. The control module 201 outputs a first control signal to the fixture 14. The fixture 14 and the connector of the external device 300 are in fixed connection. The control module 201 outputs a second control signal to the transmission module 102. The transmission module 102 controls the telescopic bracket 13 to compress while the connector 12 stays still. The telescopic bracket 13 compresses to connect the connector 12 of the interface module 101 to the connector of the external device 300.

To remove the external device 300, the control module 201 outputs a third control signal. The transmission module 102 receives the third control signal and controls the telescopic bracket 13 to return to disconnect the connector 12 of the interface module 101 from the connector of the external device 300. The control module outputs a fourth control signal to control the fixture 14 to disconnect from the connector of the external device 300.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An automatic telescopic connector, comprising:
a transmission module; and
an interface module comprising a trigger unit, a connector, and a telescopic bracket further comprising a fixture;
wherein the trigger unit is configured to sense an input signal and output a trigger signal when the input signal meets a trigger condition, the transmission module is coupled to the interface module, the automatic telescopic connector is coupled to a control module, the control module outputs a first control signal to the interface module when the control module receives the trigger signal, the control module outputs a second control signal to the transmission module when the control module receives the trigger signal, the telescopic bracket is fixed to a connector of an external device through the fixture when the interface module receives the first control signal, the transmission module controls the telescopic bracket to compress to connect the connector of the external device to the connector of the interface module when the transmission module receives the first control signal, the transmission module controls the telescopic bracket to return to disconnect the connector of the external device from the connector of the interface module when the transmission module receives a third control signal from the control module.

2. The automatic telescopic connector of claim 1, wherein the telescopic bracket is made of metal.

3. The automatic telescopic connector of claim 1, wherein the connector of the interface module is a Universal Serial Bus connector.

4. The automatic telescopic connector of claim 1, wherein the trigger unit is a pressure sensor.

5. A electronic device, comprising:
a control module; and
an automatic telescopic connector comprising:
a transmission module; and
an interface module comprising a trigger unit, a connector, and a telescopic bracket further comprising a fixture;
wherein the trigger unit is configured to sense an input signal and output a trigger signal when the input signal meets a trigger condition, the transmission module is coupled to the interface module, the automatic telescopic connector is coupled to a control module, the control module outputs a first control signal to the interface module when the control module receives the trigger signal, the control module outputs a second control signal to the transmission module when the control module receives the trigger signal, the telescopic bracket is fixed to a connector of an external device through the fixture when the interface module receives the first control signal, the transmission module controls the telescopic bracket to compress to connect the connector of the external device to the connector of the interface module when the transmission module receives the first control signal, the transmission module controls the telescopic bracket to return to disconnect the connector of the external device from the connector of the interface module when the transmission module receives a third control signal from the control module.

6. The electronic device of claim 5, wherein the control module is a central processing unit.

7. The electronic device of claim 5, wherein the control module is an embedded controller.

8. The electronic device of claim 5, wherein when the external device is needed to be removed from the connector of the interface module, the control module outputs a third control signal, the transmission module receives the third control signal and controls the telescopic bracket to return to disconnect the connector of the interface module from the connector of the external device, and the control module outputs a fourth control signal to control the fixture to disconnect from the connector of the external device.
